(19) United States
(12) Patent Application Publication
(10) Pub. No.: US 2016/0279682 A1
(43) Pub. Date: Sep. 29, 2016

(54) ABRASION REMOVAL SYSTEM

(71) Applicant: ALSTOM Renewable Technologies, Grenoble (FR)

(72) Inventors: Thierry AUZOLLE, Cravanche (FR); Jerome HAMBURGER, Belfort (FR); Sebastien BRUNA, Chenebier (FR)

(21) Appl. No.: 15/071,326

(22) Filed: Mar. 16, 2016

(30) Foreign Application Priority Data
Mar. 23, 2015 (EP) 15290080.9

(51) Int. Cl. B08B 5/02; B08B 5/04

(52) U.S. Cl. CPC B08B 5/02; B08B 5/04

(57) ABSTRACT

An abrasion removal system and method for removing abrasion from a brush of an electric machine, with a housing arranged around the space of the brush, a supply to blow a gaseous medium into the housing, and a suction system for intake of the abrasions out of the housing.

### CROSS-REFERENCE TO RELATED APPLICATIONS

This application claims priority to European Patent Application No. 15290080.9 filed Mar. 23, 2015, the contents of which are hereby incorporated in its entirety.

### TECHNICAL FIELD

The present disclosure relates to the removal of abrasions from brushes of electric machines. These brushes are commonly arranged at the stator and suitable for the power transmission between a bearing or collector of a rotor of an electric machine.

The electric machine is in particular a rotating electric machine such as a synchronous generator to be connected to a gas nr steam turbine (turbogenerator) or a synchronous generator to be connected to a hydro turbine (hydro generator) or an asynchronous generator or a synchronous or asynchronous electric motor or also other types of electric machines.

### BACKGROUND

In operation the brushes at the stator are subject to mechanical wear. These brushes are commonly made from carbon. The carbon particles separated from the brushes distribute within the electric machine. These carbon particles or carbon dust cause contaminations in the electric machine and can potentially lead to machine failures when the carbon dust causes short-circuits. It is proposed in the state of the art to remove the carbon dust from the brushes by means of suction devices to intake into the device at least shares of the arising carbon dust. There are also abrasion removal systems described with cleaning brushes next to the suction devices. None of the known abrasion removal systems however suffice high requirements to the grade of removal.

### SUMMARY

It is an object of the invention to provide an abrasion removal system for an electric machine which satisfies an adequate removal of abrasions.

This object is solved with the features of an abrasion removal system and an abrasion removal method according to the independent claims.

Further examples of the invention are disclosed in the

### BRIEF DESCRIPTION OF THE DRAWINGS

Further characteristics and advantages will be more apparent from the description of a preferred but non-exclusive embodiment of the abrasion removal system, illustrated by way of non-limiting example in the accompanying drawings, in which:

FIG. 1 shows a schematic perspective view of a housing of an abrasion removal system according to an example of the invention with two supply tubes fed by a supply for supplying a gaseous medium to a housing and an outlet tube above to be fed to a suction system for removing abrasions out of the housing;

FIG. 2 shows a schematic cut side view of the example of a housing of an abrasion removal system according to FIG. 1 illustrating tapered supply tubes;

FIG. 3 shows a schematic front view of the example of a housing of an abrasion removal system according to the example of FIGS. 1 and 2;

FIG. 4 shows a schematic back view of the example of a housing of an abrasion removal system according to the example of FIGS. 1 to 3;

FIG. 5 shows a perspective view of an example of a housing of the abrasion removal system similar to FIGS. 1-4 with a brush arranged through the housing, a brush holder, and an adjacent slip ring at the rotor side;

FIG. 6 shows a block diagram of an abrasion removal system illustrating the principle of the invention in a schematic and simplified way.

### DETAILED DESCRIPTION

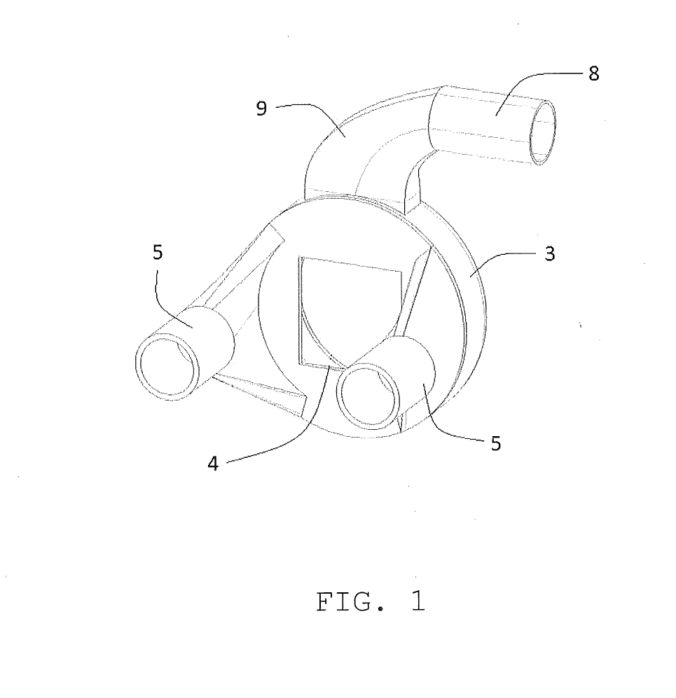

With reference to the figures, these show in FIGS. 1-4 an example of the invention and in FIG. 6 the principle of the invention, wherein like reference numerals designate identical or corresponding parts throughout the several views.

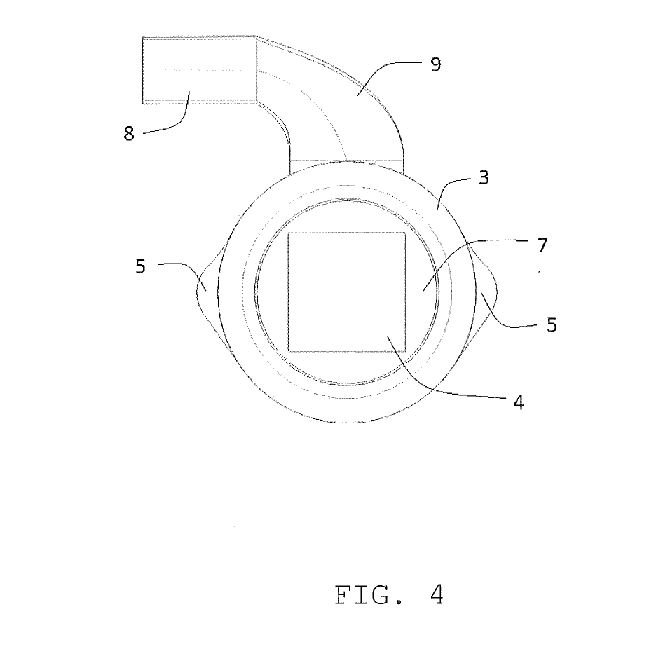

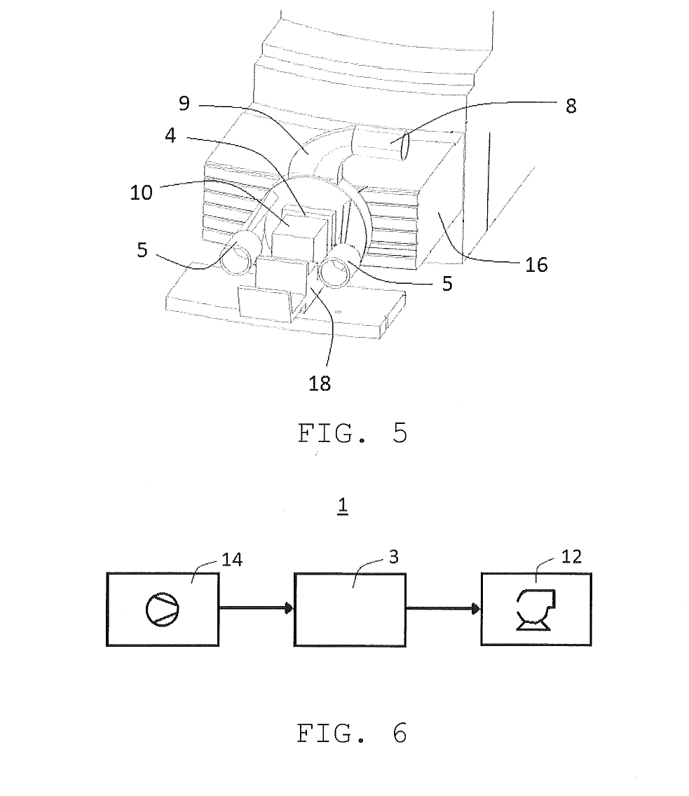

FIG. 1 shows a schematic perspective view of a housing 3 of an abrasion removal system 1 according to an example of the invention. Shown is a round housing 3 with two circular surfaces enclosing a brush 10 of an electric machine. The inlet for the brush 10 is illustrated by an opening 4 in the housing 3 in the front flat surface. The outlet for the brush 10 is illustrated by a cavity 4 in the housing 3 in the back flat surface of the housing 3, clearer illustrated in FIG. 4. The cavity 7 in the back surface has a bigger size than the opening 4 in the front surface. The back surface of the housing 3 is oriented in the direction to the rotor for the brush 10 to touch. The brush 10 is arranged at a stator of an electric machine and serves for a current transfer from the stator (foreground of FIG. 1) to the rotor (background of FIG. 1) of an electric machine. When the housing 3 is installed at the brush 10 then the opening 4 is closed by the volume of the brush 10, as can be seen in FIG. 5. Further, the cavity 7 is confined at the back by a rotor part, and thus the whole housing 3 is closed against the surrounding, as can be seen in FIG. 5. It is visible in FIG. 1 that the housing 3 when arranged at the brush 10 covers the free space around the brush 10. This free space is the closed round area around the brush 10 in the housing 3. In this example two supply tubes 5 are arranged at the housing 3 which project perpendicularly from the housing 3. The supply tubes 5 are integrated with the housing 3 on opposite edges of the housing 3. The supply tubes 5 have partly a cylindric shape distant from the housing 3 and expand more and more in the direction nearer to the housing 3. In the expanded part the supply tubes 5 have a flatter shape and a bended cuboid shape, bended according to the bending curve of the housing 3, as can be seen in FIG. 1. The cylindric parts or terminals of the supply tubes 5 are connected to a supply for a gaseous medium 14, as can be seen in FIG. 6 in a schematic way. The supply for a gaseous medium 14, also referred to shortly as supply 14, blows a gaseous medium through the supply tubes 5 into the housing 3. The gaseous medium can be air in an example. The supply 14 comprises a compressor for compressing the gaseous medium and blowing it into the housing 3 with pressure. The stream of the gaseous medium is directed into the housing 3 along the brush 10. The generated pressure is suitable to remove and disperse the abrasion from the brush 10 occurring in operation when the rotor part slides along the brush 10. The pressure exerted by the supply 14 is approximately 1.000 Pa in an example. The abrasion, usually carbon dust, is dispersed within the closed housing 3. It is essential that the abrasion when dispersed by the gaseous medium cannot escape from the space around the brush 10 confined by the housing 3. The housing 3 is manufactured with high precision to adjust to the surface of the rotor part, e.g. a slip ring 16, and to keep the gap between the rotor part and the housing small. According to the invention the abrasion does not pollute the electric machine outside the housing 3 of the brush 10. A third tube is arranged at the housing 3, an outlet tube 8. The outlet tube 8 contains a cylindric part and a bended part 9. The cylindric part projects perpendicular to the supply tubes 5 and tangential to the housing 3. The bended part 9 of the outlet tube 8 has the shape of a bended cuboid tapered in the direction away from the housing 3 and which connects the cylindric part with the housing 3 to create an outlet of the housing 3. The cylindric parts of the outlet tube 9 and also the supply tubes 5 also fulfill the function of terminals to connect. The outlet tube 8 is connected to a suction system 12, shown schematically in FIG. 6, which generates a suction power which is applied to the housing 3 via the outlet tube 8. The suction system 12 is a ventilator in an example of the invention. The suction system 12 is operated contemporary with the supply 14. The abrasion dispersed in the housing 3 by the supply 14 is absorbed by the suction system 12 which further comprises a container for storage of the abrasion.

The abrasion removal system 1 thus comprises the housing 3 with supply tubes 5, outlet tube 8, suctions system 12, and supply for a gaseous medium 14, as is shown in FIG. 6. As described above, the abrasion is removed from the brush 10, dispersed within the housing 3, and removed from the housing 3.

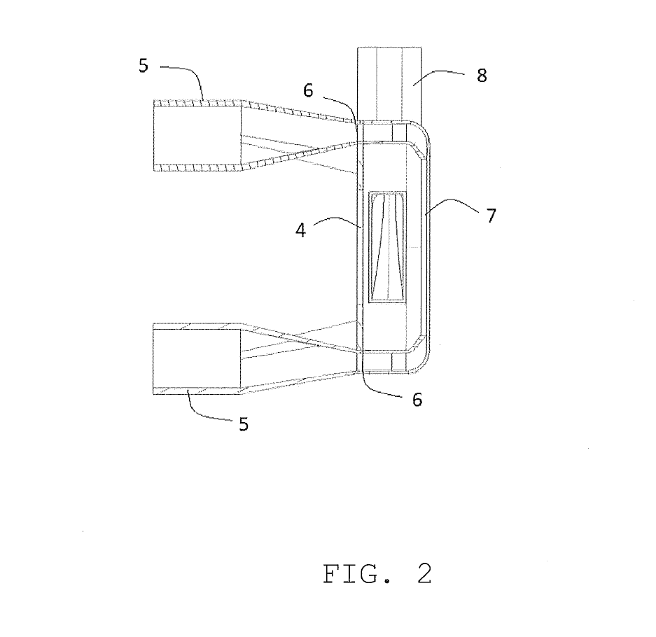

FIG. 2 shows a schematic cut side view of the example of the housing 3 of the abrasion removal system 1 according to FIG. 1. In this view the two different parts of the supply tubes 5 at the left can be seen, the cylindric part and the tapered part. Shown is in the cut view the opening 4 in the left face of the housing 3 for introducing the brush 10 from the left to the right in this perspective. The opening 4 is adjusted for insertion of the brush 10 and thus the opening 4 is completely closed in operation. At the right side in this perspective the brush 10 projects slightly from the housing 3 through the cavity 7 in the right face of the housing 3 and touches a bearing, collector, or slip ring 16 of a rotor. The abrasion removal system 1 is designed in a way that the housing does not touch the slip ring 16 in operation.

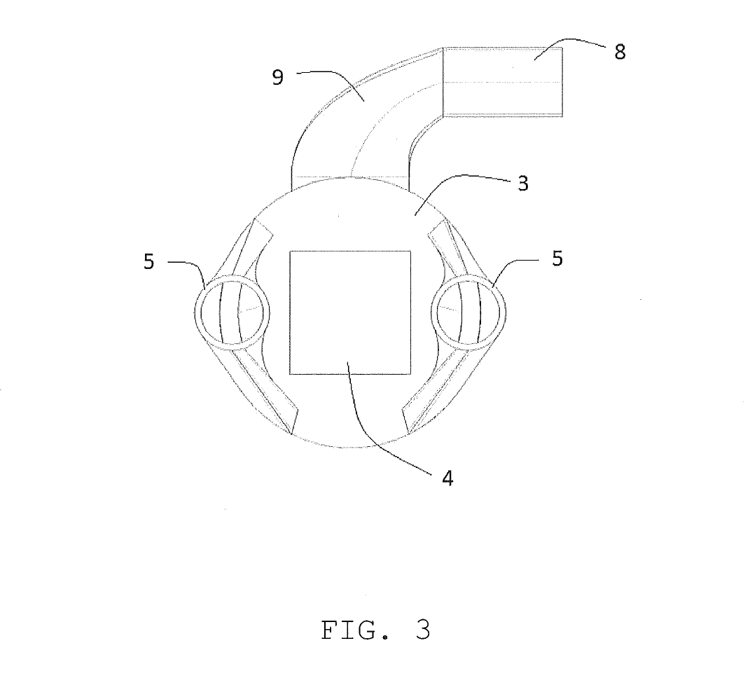

FIG. 3 shows a schematic front view of the example of the housing 3 of an abrasion removal system 1 according to the example of FIGS. 1 and 2. In particular in this view the opening 4 in the housing 3 can be seen, which is adjusted to accommodate the brush 10 so that the brush 10 is fixed in the frame of the opening 4. As the brush 10 has commonly a cuboid shape, the opening 4 in the wall of the housing 3 has a corresponding rectangular shape.

FIG. 4 shows a schematic back view of the housing 3 of an abrasion removal system 1 according to the example of FIGS. 1 to 3. The back side of the housing 3 which is shown in the foreground in FIG. 4, is the side aligned to the rotor part, e.g. the slip ring 16. This is the side at which the brush 10 slides along the slip ring 16 and collects the current generated. Here, in particular, the cavity 7 in the housing 3 is shown exemplary. In operation, again the cavity is confined by the slip ring 16. The cavity 7 has a round shape and a circle is cut out from the wall of the housing 3. The cavity 7 has a bigger diameter than the opening 4 which is in the background in the perspective according to FIG. 4. The diameter of the cavity 7 can be extended up to the whole surface of the housing 3. The diameter of the cavity 7 has to be higher than the diameter of the opposed opening 4 as by this means the space next to the brush 10 can be effected by the supply 14 and the suction system 12 for the abrasion to be removed also in this space.

FIG. 5 shows a perspective view of an example of the housing 3 of the abrasion removal system 1 similar to FIGS. 1-4 which is installed at the stator side of the rotating electric machine. In FIG. 5 the brush 10 is connected to a brush holder 18 that consists of a plate and a holding device on the plate to accommodate the brush 10. In the foreground of the perspective view the brush 10 is clamped at the brush holder 18 and projects through the opening 4 of the housing 3. At the opposite side of the housing 3 at the other flat face of the housing 3 the brush 10 projects out of the housing 3 to abut the slip ring 16 which is connected to the rotor.

FIG. 6 shows a block diagram of an abrasion removal system 1 illustrating the principle of the invention in a schematic and simplified way. The abrasion removal system 1 contains the supply for a gaseous medium 14, the housing 3, and the suction system 12. The left block shows the supply for a gaseous medium 14, e.g. comprising a compressor. This supply 14 is connected to the terminals of the supply tubes 5 of the housing 3. The supply 14 blows a gaseous medium into the housing 3 which develops a flow stream around the brush. By means of this stream of gaseous medium abrasions of the brush 10 are removed from the surface of the brush 10 and follow the gaseous stream inside the housing 3. The suction system 12 is connected to the terminals of the outlet tube 8 at the cylindric part of the outlet tube 8. Here, the suction system 12 comprises a ventilator. The stream of gaseous medium with the abrasion inside the housing 3 is attracted and sucked by the intake pressure generated by the suction system 12. The abrasion is either discharged or filtered and to be stored in a container finally. A transfer of the gaseous medium from the supply 14 to the suction system 12 occurs. The abrasion removal system 1 can in a further example be designed as a closed system in which the output of the suction system 12 defines the input of the supply 14. In this example of a closed loop the stream of gaseous medium is filtered between the suction system 12 and the supply 14 to filter out the abrasion.

While the invention has been described in detail with reference to exemplary embodiments thereof, it will be apparent to one skilled in the art that various changes can be made, and equivalents employed, without departing from the scope of the invention. The foregoing description of the preferred embodiments of the invention has been presented for purposes of illustration and description. It is not intended to be exhaustive or to limit the invention to the precise form disclosed, and modifications and variations are possible in light of the above teachings or may be acquired from practice of the invention. The embodiments were chosen and described in order to explain the principles of the invention and its practical application to enable one skilled in the art to utilize the invention in various embodiments as are suited to the particular use contemplated. It is intended that the scope of the invention be defined by the claims appended hereto, and their equivalents.

1. An abrasion removal system for removing abrasion from a brush of an electric machine, comprising in a housing arranged around the space of the brush, a supply to blow a gaseous medium into the housing, and a suction system for intake of the abrasions out of the housing.

2. The abrasion removal system according to claim 1, wherein the supply comprises a compressor for blowing air into the housing.

3. The abrasion removal system according to claim 1, wherein the supply comprises two supply tubes arranged at the housing with each a passage to the housing for blowing the gaseous medium into the housing through the supply tubes.

4. The abrasion removal system according to claim 1, wherein the suction system comprises a ventilator.

5. The abrasion removal system according to claim 1, wherein the suction system comprises an outlet tube arranged at the housing with a passage to the housing for intaking the abrasion through the outlet tube.

6. The abrasion removal system according to claim 1, wherein the housing encloses the brush completely with an opening in the housing serving as an inlet for the brush at one side and in that the housing has a cavity at the other side that is aligned to a rotor part to abut the brush.

7. Abrasion removal method for removing abrasion from a brush of an electric machine with the steps of blowing a compressed gaseous medium into a housing surrounding the brush, and intaking the abrasion out of the inside of the housing.
